(19) United States
(12) Patent Application Publication
(10) Pub. No.: US 2026/0253243 A1
(43) Pub. Date: Aug. 27, 2026

(54) METHOD FOR EXTRACTING LIGHT STRIPE CENTER POINTS OF LASER STRIPES IN SEARCH PARTITION, AND ROBOT

(71) Applicant: AMICRO TECHNOLOGY CO., LTD., Zhuhai (CN)

(72) Inventors: Yingliang JIANG, Zhuhai (CN); Jianfeng DAI, Zhuhai (CN)

(73) Assignee: AMICRO TECHNOLOGY CO., LTD., Zhuhai (CN)

(21) Appl. No.: 19/649,029

(22) Filed: Apr. 15, 2026

Related U.S. Application Data
(63) Continuation of application No. PCT/CN2024/124239, filed on Oct. 11, 2024.

(30) Foreign Application Priority Data
Oct. 27, 2023 (CN) 202311407953.5

(51) Int. Cl. G06T 7/66; G06T 7/11; G06T 7/80; G06T 7/90

(52) U.S. Cl. CPC G06T 7/66; G06T 7/11; G06T 7/80; G06T 7/90; G06T 2207/10048

(57) ABSTRACT

A method for extracting light stripe center points of laser stripes in a search partition includes: Step A, selecting an initial search partition, and extracting a start center point; Step B, setting a search partition adjacent to the initial search partition in a first predetermined searching direction as a current search partition, setting a current search center point in the current search partition based on the start center point, setting a current search sub-partition with the current search center point as a center in a second predetermined searching direction and a direction opposite to the second predetermined searching direction, and extracting a light stripe center point in the current search sub-partition; and Step C, updating the current searching partition as a new initial search partition, and updating the light stripe center point in the current search sub-partition as a new start center point, and proceeding to Step B.

### CROSS-REFERENCE TO RELATED APPLICATIONS

This application is a continuation application of International Application No. PCT/CN2024/124239, filed on Oct. 11, 2024, which claims priority to Chinese Patent Application No. 202311407953.5, filed on Oct. 27, 2023. The disclosures of the above-mentioned applications are hereby incorporated by reference in their entireties.

### TECHNICAL FIELD

The present disclosure relates to the field of laser data processing, in particular to a method for extracting light stripe center points of laser stripes in a search partition, and a robot.

### BACKGROUND

In such fields as computer vision, image processing and target tracking, the extraction of a center-of-mass (also called as center-of-gravity) point of an object is a basic task, and it is crucial to the detection, tracking, identification and measurement of a target. Usually, the center-of-mass of the object is used to describe a position and a posture of the object for the subsequent analysis and processing.

Chinese Patent Publication CN115619860A fails to position a laser beam directly within a single frame, and instead, a reflection position of the laser beam is tracked according to a matching relationship between a previous frame and a current frame. In a process of tracking the reflection position of the laser beam, in a case of updating a search center in a single column, a coordinate span between two search centers (search start points) before and after the updating is not obvious, and thereby two adjacent search ranges mostly overlap with each other. At this time, it will take time to process an overlapping range. Actually, a pixel width of a light stripe in an image only occupies a very small proportion of a width or length of the image, and in a case that pixels in the entire image are traversed row by row or column by column, a huge number of resources need to be consumed to process invalid pixels, and light stripe center points in each column cannot be extracted in real time.

Because the pixel width of the light stripe in the image only occupies a very small proportion (5% to 10%) of the width or length of the image, a grayscale value of the light stripe is far greater than a grayscale value of a background including the light stripe. In CN115619860A, in a case that a camera is not equipped with an infrared filter, there is a background noise for screening the light stripe center points in each column on the basis of such a rule that the grayscale values decrease gradually at two sides of the search center.

In Chinese Patent Publication CN115619860A, a grayscale center-of-gravity algorithm is performed in part of frames with low brightness, and a center-of-gravity of an object is determined according to a grayscale value of a pixel in the image. Although subpixel-level accuracy is achieved through this algorithm, all the pixels in the entire image need to be traversed globally, e.g., the pixels are traversed sequentially from a pixel in a current column and a first row to a pixel in the current column and a last row, and from a pixel in a current row and a first column to a pixel in the current row and a last column. However, the pixel width of the light stripe in the image only occupies a very small proportion (5% to 10%) of the width or length of the image, so a huge number of resources are consumed to process the invalid pixels, and the light stripe center points in each column cannot be extracted in real time.

### SUMMARY

An object of the present disclosure is to provide a method for extracting a light stripe center point of a laser stripe in a search partition, and a robot. The present disclosure provides the following technical solutions.

In one aspect, the present disclosure provides in some embodiments a method for extracting light stripe center points of laser stripes in a search partition. A robot is configured to control a linear laser generator to generate a laser beam, control a camera to collect an image of the laser stripes formed through the reflection of the laser beam, and mark the image of the laser stripes as a laser image; the laser image is divided evenly into a plurality of search partitions in a length direction of a laser stripe in the laser stripes to allow that the laser stripe includes an individual light stripe partition in an individual search partition; the length direction of the laser stripe is a first predetermined searching direction or a direction opposite to the first predetermined searching direction; wherein the method includes:
Step A, selecting an initial search partition from the plurality of search partitions of the laser image, extracting a center-of-gravity point of the initial search partition based on a grayscale center-of-gravity method, marking the center-of-gravity point of the initial search partition as a start center point, and determining that the initial search partition has been searched, wherein in the initial search partition, a distribution direction of pixels is pre-calibrated to be parallel to a width direction of the laser stripe, and the length direction of the laser stripe is perpendicular to the width direction of the laser stripe; Step B, setting a search partition in the plurality of search partitions adjacent to the initial search partition in the first predetermined searching direction as a current search partition, setting a current search center point in the current search partition based on the start center point, setting a current search sub-partition in a second predetermined searching direction and a direction opposite to the second predetermined searching direction with the current search center point as a center, extracting a center-of-gravity point of the current search sub-partition based on the grayscale center-of-gravity method, marking the center-of-gravity point of the current search sub-partition as a light stripe center point of the laser stripe in the current search sub-partition, and determining that the current search partition has been searched and the light stripe center point has been extracted in the current search partition, wherein the second predetermined searching direction is perpendicular to the first predetermined searching direction; and Step C, updating the current search partition as a new initial search partition, updating the light stripe center point of the laser stripe in the current search sub-partition as a new start center point, and proceeding to Step B until all the search partitions in the laser image have been searched, to extract the light stripe center point of the laser stripe in the light stripe partition; the light stripe center point in the current search sub-partition corresponds to the light stripe center point of the laser stripe in the corresponding light stripe partition.

In a word, in the embodiments of the present disclosure, through Steps A to C, the start center point is determined in the initial search partition, and the light stripe center point of the laser stripe in a corresponding light stripe partition is extracted through recursive extraction of the other search partitions and search center points combined with the grayscale center-of-gravity method. The other search partition is a small pixel region defined with a predetermined light stripe center point as a search center. As a result, it is unnecessary to search the pixels in the laser image one by one, thereby to reduce an extraction time of the search center point without adversely affecting the extraction accuracy of the light stripe center point, improve the extraction efficiency of the light stripe center point, and save memory resources.

In another aspect, the present disclosure provides in some embodiments a robot. A body of the robot is equipped with a linear laser module, the linear laser module includes a linear laser generator and a camera; a laser beam generated by the linear laser generator is reflected by a to-be-measured surface toward the camera to form laser stripes; the laser stripes are included in an image collected by the camera to generate a laser image for the robot; the laser stripes include a plurality of light stripe partitions in the laser image; the laser image is evenly divided into a plurality of search partitions in a length direction of the laser stripe; the robot is configured to execute the above-mentioned method, and a light stripe center point calculated in a search partition in the plurality of search partitions corresponds to a light stripe center point of the laser stripe in a corresponding light stripe partition in the plurality of light stripe partitions; before executing the method by the robot, the camera is pre-calibrated in such a manner that a distribution direction of pixels in a search partition in the plurality of search partitions in the laser image is parallel to a width direction of the laser stripe; and the length direction of the laser stripe is perpendicular to the width direction of the laser stripe, the width direction of the laser stripe is parallel to a second predetermined searching direction, and the length direction of the laser stripe is parallel to a first predetermined searching direction.

In the embodiments of the present disclosure, through Steps A to C, the robot determines the start center point in the initial search partition, and extract the light stripe center point of the laser stripe in a corresponding light stripe partition through recursive extraction of the other search partitions and search center points combined with the grayscale center-of-gravity method. The other search partition is a small pixel region defined with a predetermined light stripe center point as a search center, and the updating is performed from the start center point. As a result, it is unnecessary to search the pixels in the laser image one by one, thereby to reduce an extraction time of the search center point without adversely affecting the extraction accuracy of the light stripe center point, improve the extraction efficiency of the light stripe center point, and save memory resources.

### BRIEF DESCRIPTION OF THE DRAWINGS

FIG. 1 is a flow chart of a method for extracting light stripe center points of laser stripes in a search partition according to an embodiment of the present disclosure.

FIG. 2 is a schematic view showing a situation where light stripe center points are searched from left to right in a plurality of search partitions (cell regions in each column) in a pixel coordinate system UOV according to an embodiment of the present disclosure (apart from a first column from the left, a cell region covered by each arrow in each column is a pixel region in which a center-of-gravity point (a light stripe center point of a laser stripe in a current search sub-partition, also called as a light stripe center point in the current search sub-partition, or a light stripe center point extracted in a current search partition or a current search sub-partition) needs to be calculated, a white dot represents the center-of-gravity point or the light stripe center point, and a black box where the white dot is located represents a cell region occupied by the light stripe center point).

### DETAILED DESCRIPTION OF THE EMBODIMENTS

The technical solutions in the embodiments of the present disclosure will be described hereinafter in details in conjunction with the drawings. The drawings constitute a part of the present disclosure, and they are used to describe the embodiments and explain a principle in combination with the relevant description in the specification. Based on the embodiments of present disclosure and the drawings, the other possible embodiments and the benefits of the present disclosure will be apparent to a person skilled in the art.

The present disclosure provides in some embodiments a method for extracting light stripe center points of laser stripes in a search partition, and specifically this method is used to extract light stripe information generated due to the reflection of a laser beam on a to-be-measured surface, so as to position the to-be-measured surface. The method is executed by a robot which performs navigation and positioning using a linear laser beam. The robot is equipped with a linear laser module, and the linear laser module includes a linear laser generator and a camera. The robot is configured to control the linear laser generator to generate the laser beam, control the camera to collect an image of the laser stripes formed through the reflection of the laser beam, and mark the image of the laser stripes as a laser image.

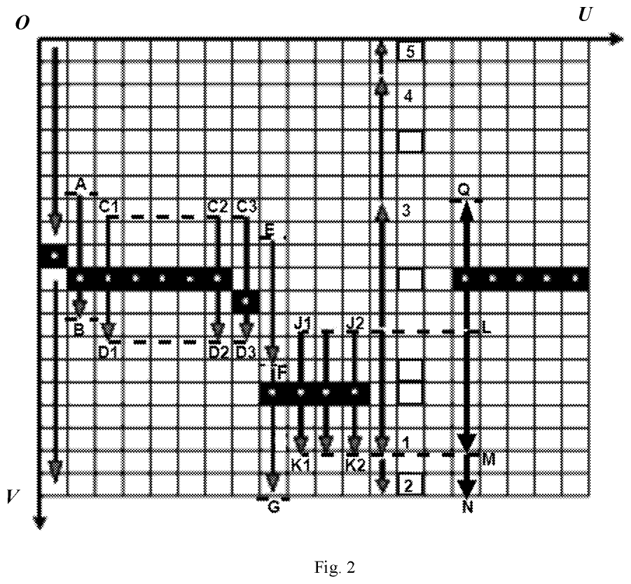

In the embodiments of the present disclosure, the laser image is evenly divided into a plurality of search partitions in a length direction of the laser stripe, so that the laser stripe includes an individual light stripe partition in an individual search partition. In a case that the search partitions are present in the form of columns in a pixel coordinate system UOV in FIG. 2, the laser stripe occupies corresponding pixel coordinate positions in the form of black cells in FIG. 2, which are marked as the individual light stripe partition of the laser stripe in the individual search partition. A white dot in FIG. 2 represents the light stripe center point, which needs to be searched and positioned through the method. In order to reduce a computing burden, in the embodiments of the present disclosure, the length direction of the laser stripe is set as a first predetermined searching direction or a direction opposite to the first predetermined searching direction. A length of the laser stripe is greater than a width of the laser stripe. In a process of calibrating the camera, the first predetermined searching direction is configured in advance as to be parallel to a coordinate axis of the pixel coordinate system UOV, i.e., the length direction of the laser stripe is calibrated as to be parallel to the first predetermined searching direction or the first predetermined searching direction is calibrated as the length direction of the laser stripe. The length direction of the laser stripe depends on an assembling angle and an assembling height of the camera relative to the linear laser generator, specifically the assembling angle and the assembling height of the calibrated camera relative to the calibrated linear laser generator. The length direction of the laser stripe is calibrated through calibrating intrinsic parameters using a calibration plate or any other calibration tools before performing the method.

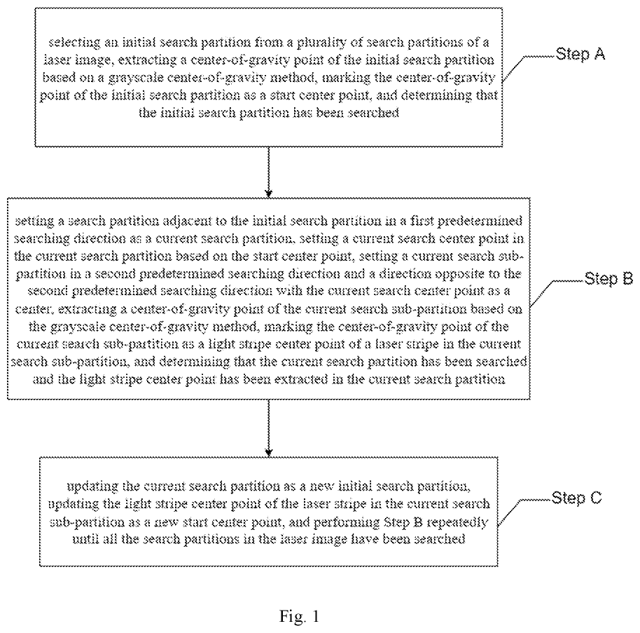

Referring to FIG. 1, the method includes the following steps.

Step A: an initial search partition is selected from the plurality of search partitions of the laser image. Usually the initial search partition extracted/searched in the laser image is a search partition which is closest to a boundary of the laser image and in which a light stripe center point can be extracted. A center-of-gravity point of the initial search partition is extracted based on a grayscale center-of-gravity method. Here, before extracting the center-of-gravity point, a grayscale value of each pixel in the initial search partition is detected to determine whether or not the grayscale center-of-gravity method is to be used, so as to prevent a waste of computing power for invalid pixels. In some embodiments of the present disclosure, the calculation is performed based on all the pixels in the initial search partition to roughly but globally determine the center-of-gravity point. The center-of-gravity point of the initial search partition is marked as a start center point, and the initial search partition is determined to have been searched.

In the initial search partition, a distribution direction of pixels is pre-calibrated to be parallel to a width direction of the laser stripe, and the length direction of the laser stripe is perpendicular to the width direction of the laser stripe. As shown in FIG. 2, the initial search partition is a cell region in a first column from left to right, there are two arrows above and below a black cell in the cell region in the first column, and a white dot in the black cell is the start center point. Hence, the initial search partition may be considered as to be perpendicular to the width direction of the laser stripe. A center point of a light stripe of the laser stripe in the initial search partition is calculated using the grayscale center-of-gravity method, so as to form the light stripe center point in the initial search partition. Preferably, in the initial search partition, the distribution direction of the pixels is parallel to the width direction of the laser stripe.

Step B, a search partition in the plurality of search partitions adjacent to the initial search partition in the first predetermined searching direction is set as a current search partition. In a case that the initial search partition is the cell region in the first column from left to right in FIG. 2, the search partition adjacent to the initial search partition in the first predetermined searching direction is a cell region in a second column. In a case that the initial search partition is updated as a cell region in an R^{th} column (R is greater than 1), the current search partition is updated as a cell region in an (R+1)^{th} column. A current search center point is set in the current search partition based on the start center point. In order to track the light stripes of the laser stripes in different search partitions in the first predetermined search direction, usually the start center point is moved horizontally along the first predetermined searching direction to the current search partition to form the current search center point. A current search sub-partition is set in a second predetermined searching direction and a direction opposite to the second predetermined searching direction with the current search center point as a center. Usually, the current search sub-partition set for the first time is located in the current search partition. In a case that the center-of-gravity point cannot be calculated in the current search sub-partition due to such factors as grayscale values, a next search sub-partition is selected in a same search partition as a new current search sub-partition, or a next search sub-partition is selected in the second predetermined searching direction or the direction opposite to the second predetermined searching direction as a new current search sub-partition, and then the current search center point is updated. Of course, after updating the current search partition, the current search sub-partition and the search center point are updated too.

In Step B, the center-of-gravity point of the current search sub-partition is extracted based on the grayscale center-of-gravity method, and as compared with a situation where all the pixels in the entire search partition are searched and calculated, it is able to save a memory space for the pixels, and calculate the center-of-gravity point rapidly. The center-of-gravity point of the current search sub-partition is marked as the light stripe center point of the laser stripe in the current search sub-partition, the current search partition is determined to have been searched, and then the light stripe center point is determined to have been extracted in the current search partition.

Step C, the current search partition is updated as a new initial search partition, the light stripe center point of the laser stripe in the current search sub-partition is updated as a new start center point, and Step B is performed repeatedly until all the search partitions in the laser image have been searched. In a case that the search partitions are arranged in the laser image in columns (correspondingly, the width direction of the laser stripe is perpendicular to a movement plane of the robot), Step B is performed repeatedly in such a manner that the initial search partition and the start center point are updated column by column, until all the search partitions in the laser image have been searched to obtain a group of light stripe center points distributed in rows. In this way, the light stripe center points of the laser stirpes in the light stripe partitions (black cells each including a white dot in FIG. 2) are extracted. The light stripe center point in the current search sub-partition corresponds to the light stripe center point of the laser stripe in the corresponding light stripe partition. In a case that the laser stripe changes in the corresponding light stripe partition, the current search sub-partition and the light stripe center point therein also change, so as to achieve a tracking effect.

Illustratively, as shown in FIG. 2, from left to right, the light stripe center points are searched column by column, i.e., in a cell region in a second column (a search partition where cells indicated by an arrow AB are located), a cell region in a third column (a search partition where cells indicated by an arrow C1D1 are located), a cell region in a fourth column, . . . , a cell region in a seventh column (a search partition where cells indicated by an arrow C2D2 are located), and a cell region in an eighth column (a search partition where cells indicated by an arrow C3D3 are located). Ordinates of the light stripe center points extracted in the cell regions in the second column, the third column, the fourth column, . . . , and the seventh column are the same, and the search partitions covered by the cell regions in the third column, the fourth column, . . . , the seventh column and the eighth column are located within a same ordinate range.

Illustratively, as shown in FIG. 2, from left to right, no light stripe center points are included in cell regions between a cell region in a twelfth column and a cell region in a sixteenth column, i.e., search partitions without any light stripe center points are arranged in columns between the cell region in the twelfth column to the cell region in the sixteenth column. An ordinate of each black cell in the cell region in the twelfth column through which an arrow J2K2 passes is not equal to an ordinate of each black cell in the cell region in the sixteenth column through which an arrow LQ passes, and a direction to which the arrow LQ points is opposite to a direction to which the arrow J2K2 points. It means that, in the cell region in the sixteenth column, no light stripe center points are extracted in the search sub-partitions below the ordinate of the black cell through which the arrow J2K2 passes, and the light stripe center points are merely extracted in the search sub-partitions above the ordinate of the black cell through which the arrow J2K2 passes. In the cell region in the sixteenth column, the search sub-partitions above the ordinate of the black cells through which the arrow J2K2 passes are the cell region through which the arrow LQ passes.

In a word, in the embodiments of the present disclosure, through Steps A to C, the start center point is determined in the initial search partition, and the light stripe center point of the laser stripe in a corresponding light stripe partition is extracted through recursive extraction of the other search partitions and search center points combined with the grayscale center-of-gravity method. The other search partition is a small pixel region defined with a predetermined light stripe center point as a search center. As a result, it is unnecessary to search the pixels in the laser image one by one, thereby to reduce an extraction time of the search center point without adversely affecting the extraction accuracy of the light stripe center point, improve the extraction efficiency of the light stripe center point, and save memory resources.

In a possible embodiment of the present disclosure, Step B specifically includes the following steps.

Step B1, determining whether the current search sub-partition includes an effective pixel region based on a predetermined grayscale threshold; in a case that the current search sub-partition includes the effective pixel region, extracting the effective pixel region from the current search sub-partition, and proceeding to Step B2; and in a case that the current search sub-partition does not include the effective pixel region, proceeding to Step B3. In other words, in a case that the robot determines that there is the effective pixel region in the current search sub-partition, the effective pixel region is extracted in the current search sub-partition, and then Step B2 is performed. In a case that the robot determines that there is no effective pixel region in the current search sub-partition, Step B3 is performed. The current search sub-partition is determined in the current search partition as mentioned hereinabove. In the embodiments of the present disclosure, through the predetermined grayscale threshold, it is able to filter out background pixels in the current search sub-partition, thereby to prevent the extraction of the light stripe center points from being interfered.

The current search sub-partition is a search sub-partition searched by the robot in the current search partition in Step B1 or Step B.

Step B2, extracting a center-of-gravity point of the effective pixel region based on a grayscale center-of-gravity method, determining that the center-of-gravity point of the current search sub-partition has been extracted, marking the center-of-gravity point of the current search sub-partition as the light stripe center point of the laser stripe in the current search sub-partition, and determining that the current search partition has been searched and the light stripe center point has been extracted in the current search partition. As shown in FIG. 2, through Steps B1 and B2, the robot extracts the light stripe center points in the cell regions in the second to eighth columns, and one light stripe center point is extracted in the current search sub-partition in the cell region in each column (the current search partition or the new initial search partition). Then, Step B5 is performed to determine whether the robot has searched all the search partitions in the laser image.

Step B3, determining whether the current search sub-partition currently covers a boundary of the current search partition in the second predetermined searching direction; in a case that the current search sub-partition currently covers the boundary of the current search partition in the second predetermined searching direction, determining that the boundary of the current search partition in the second predetermined searching direction has been searched, and proceeding to Step B4; and in a case that the current search sub-partition currently does not cover the boundary of the current search partition in the second predetermined searching direction, proceeding to Step B7 to continue to perform the searching in the current search partition. The boundary of the current search partition in the second predetermined searching direction is included in a boundary of the laser image in the second predetermined searching direction. A boundary of the current search partition in the direction opposite to the second predetermined searching direction is a boundary in the current search partition to which the direction opposite to the second predetermined searching direction points.

To be specific, in a case of determining whether the current search sub-partition covers the boundary of the current search partition in the second predetermined searching direction, the robot determines whether the current search sub-partition reaches the boundary of the laser image in the second predetermined searching direction in a process of searching the search sub-partition in the second predetermined searching direction.

In a case that the current search sub-partition covers the boundary of the current search partition in the second predetermined searching direction, a boundary of the current search sub-partition in the second predetermined searching direction overlaps with the boundary of the current search partition in the second predetermined searching direction, or the boundary of the current search partition in the second predetermined searching direction is located inside the current search sub-partition. Then, Step B4 is performed.

In a case that the current search sub-partition does not cover the boundary of the current search partition in the second predetermined searching direction, the boundary of the current search sub-partition in the second predetermined searching direction is spaced apart from the boundary of the current search partition in the second predetermined searching direction by a certain distance, and then Step B8 is performed.

Step B4, determining whether the boundary of the current search partition in the direction opposite to the second predetermined searching direction has been searched; in a case that the boundary of the current search partition in the direction opposite to the second predetermined searching direction has been searched, proceeding to Step B5 to determine whether the current search partition has been searched but no light stripe center point is extracted in the current search partition; and in a case that the boundary of the current search partition in the direction opposite to the second predetermined searching direction has not been searched, updating the direction opposite to the second predetermined searching direction as the second predetermined searching direction, and proceeding to Step B6.

In Step B4, the robot has determined that the current search sub-partition currently covers the boundary of the current search partition in the second predetermined searching direction, but it needs to determine whether the boundary of the current search partition in the direction opposite to the second predetermined searching direction has been searched. In a case that the boundary of the current search partition in the direction opposite to the second predetermined searching direction has been searched, it determines, on the basis of an order of the above steps, that the light stripe center point is not extracted in the current search partition in a process of performing the searching in the current search partition in the second predetermined searching direction. In a case that the boundary of the current search partition in the direction opposite to the second predetermined searching direction has not been searched, it needs to subsequently perform the searching in the current search partition in the direction opposite to the second predetermined searching direction. To be specific, the direction opposite to the second predetermined searching direction is updated as the second predetermined searching direction, and then Step B6 is performed, so as to extract the light stripe center point in the current search partition. This is because, the light stripe center point fails to be extracted in the current search sub-partition set in the current search partition in the second predetermined searching direction based on the start center point.

Step B5, determining whether the current search sub-partition currently covers a boundary of the laser image in the first predetermined searching direction; in a case that the current search sub-partition currently covers the boundary of the laser image in the first predetermined searching direction, determining that all search partitions in the laser image have been searched; and in a case that the current search sub-partition currently does not cover the boundary of the laser image in the first predetermined searching direction, proceeding to Step C. To be specific, the robot updates the current search partition as the initial search partition, and updates the light stripe center point of the laser stripe in the current search sub-partition as the start center point. Then, Step B is performed, so as to set a search partition adjacent to the initial search partition in the first predetermined searching direction as the current search partition, set the current search center point in the current search partition based on the start center point, set the current search sub-partition in the current search partition for Step B1 with the current search center point as a center, and perform Step B1 repeatedly.

If Step B5 is performed directly after Step B2, in a case that the current search sub-partition covers the boundary of the laser image in the first predetermined searching direction, the light stripe center point extracted by the robot for the last time in the laser image is obtained, and the searching of all the search partitions in the laser image has been completed. At this time, Steps B and C may not be performed. Illustratively, as shown in FIG. 2, in a case that the current search sub-partition is included in a cell region in a twentieth column, the current search sub-partition covers a black cell (including a white dot) and a right boundary of the current search sub-partition reaches a right edge of the laser image, i.e., the light stripe center point cannot be extracted on the right, so all the search partitions in the laser image have been searched.

If Step B5 is performed directly after Step B4, the robot determines that the current search partition has been searched but no light stripe center points are extracted in the current search partition. In a case that the current search sub-partition covers the boundary of the laser image in the first predetermined searching direction, the light stripe center point fails to be extracted in the current search partition, although all the search partitions in the laser image have been searched. Alternatively, the light stripe center point fails to be extracted in any search partitions other than the search partition in Step A.

Step B6, updating a search sub-partition adjacent to the current search sub-partition set for the first time in the current search partition and covering a predetermined search step size in the updated second predetermined searching direction in Step B4 as a new current search sub-partition, and proceeding to Step B1. The current search sub-partition set for the first time in the current search partition may be understood as current search sub-partitions set in the second predetermined searching direction and the direction opposite to the second predetermined searching direction with the current search center point set for the first time in the current search partition as a center. Hence, the current search sub-partition set for the first time in the current search partition is included in the current search sub-partitions obtained through Step B in the current search partition. The search sub-partition set in the updated second predetermined searching direction and covering the predetermined search step size is updated as the new current search sub-partition, i.e., a length of the new current search sub-partition in the second predetermined searching direction is equal to the predetermined search step size.

In Step B6, illustratively, as shown in FIG. 2, in a case that a cell region in a thirteenth column is set as the current search partition, the second predetermined searching direction is a positive direction of a V-axis of the pixel coordinate system, i.e., a longitudinal direction. In the cell region in the thirteenth column (i.e., the current search partition), a cell region through which an arrow 2 passes covers a boundary of the current search partition in the second predetermined searching direction (a lower boundary of the cell region in the thirteenth column). At this time, the boundary of the current search partition in the direction opposite to the second predetermined searching direction has not been searched, i.e., an upper boundary of the cell region in the thirteenth column is not searched by an arrow 5. Next, the arrow 2 is adjusted to be an arrow 3, and in a direction to which the arrow 3 points, search sub-partitions adjacent to the cell region through which the arrow 1 passes and covering the predetermined search step size (an equal number of cells) in the second predetermined searching direction are set as the cell region through which the arrow 3 passes. The cell region through which the arrow 1 passes includes the current search sub-partitions set for the first time in the cell region in the thirteenth column, a V-axis coordinate of the current search center in the cell region through which the arrow 1 passes is equal to a V-axis coordinate of the light stripe center point extracted in the cell region in the twelfth column, and the current search center set in the cell region through which the arrow 1 passes is obtained through horizontally moving the black cell in the cell region in the twelfth column to the right by one cell. The direction to which the arrow 3 points is opposite to a direction to which the arrow 2 points, so as to update the direction opposite to the second predetermined searching direction as the second predetermined searching direction. In a case that the second predetermined searching direction is a vertical downward direction, the direction opposite to the second predetermined searching direction is a vertical upward direction. Then, in Step B6, the new current search sub-partition is set and the light stripe center point is extracted in the vertical upward direction.

In the cell region in the thirteenth column, the cell region through which the arrow 3 passes, a cell region through which an arrow 4 passes and a cell region through which the arrow 5 passes are provided sequentially in the vertical upward direction. The cell region through which the arrow 5 passes covers an upper boundary of the cell region in the thirteenth column (i.e., the current search sub-partition currently covers the boundary of the current search partition in the second predetermined searching direction, and here the second predetermined searching direction is obtained through updating the direction opposite to the second predetermined searching direction), but no light stripe center point is extracted in the cell region through which the arrow 5 passes. In other words, no black cell with a white dot is searched in the cell region in the thirteenth column, and the current search partition does not include the light stripe center point. Hence, a next search partition, i.e., pixels in a next column (a cell region in a fourteenth column), is processed. In addition, the light stripe center points in the cell regions in the thirteenth and fourteenth columns are extracted based on a V-axis coordinate of the light stripe center point in the pixel coordinate system extracted in the cell region in the twelfth column.

In a case that a cell region in a sixteenth column is set as the current search partition, a cell region through which an arrow MN passes covers a boundary of the current search partition in the second predetermined searching direction (a lower boundary of the cell region in the sixteenth column). At this time, the robot determines that a boundary of the current search partition in the direction opposite to the second predetermined searching direction fails to be searched, i.e., an upper boundary of the cell region in the sixteenth column fails to be searched in advance. Next, the arrow MN is adjusted to an arrow LQ. In a direction to which the arrow LQ points, a search sub-partition adjacent to the cell region through which an arrow LM passes and covering the predetermined search step size (an equal number of cells) in the second predetermined searching direction is set as the cell region through which the arrow LQ passes. The cell region through which the arrow LM passes includes the current search sub-partition set for the first time in the cell region in the sixteenth column, a V-axis coordinate of the current search center in the cell region through which the arrow LM passes is equal to a V-axis coordinate of the light stripe center point extracted in the cell region in the twelfth column, and the current search center set in the cell region through which the arrow LM passes is obtained through horizontally moving the black cell in the cell region in the twelfth column (the black cell through which the arrow J2K2 passes) to the right by one cell. In the cell region in the sixteenth column, the cell region through which the arrow LQ passes is set in the vertical upward direction, and the cell region through which the arrow LQ passes covers the black cell, so the light stripe center point is extracted in the cell region in the sixteenth column. The robot stops setting the search sub-partition and extracting the light stripe center point in the vertical upward direction, so a next search partition, i.e., pixels in a next column (a cell region in a seventeenth column), is processed. In addition, the light stripe center point in the cell region in the sixteenth column is extracted based on a V-axis coordinate of the light stripe center point in the pixel coordinate system extracted in the cell region in the twelfth column. Hence, Steps B1 and B2 are performed, so as to sequentially extract the light stripe center points in the cell regions in the seventeenth to twentieth columns, and one light stripe center point is extracted in each column, until the current search sub-partition covers the boundary of the laser image in the first predetermined searching direction in Step B5. At this time, all the search partitions in the laser image have been searched, and the light stripe center point of the laser stripe in the corresponding light stripe is extracted in the cell region in each column.

Step B7, updating the search sub-partition adjacent to the current search sub-partition and covering the predetermined search step size as a new current search sub-partition in the second predetermined searching direction, and proceeding to Step B1. The second predetermined searching direction is perpendicular to the first predetermined searching direction, the predetermined search step size is a length of the search sub-partition in the second predetermined searching direction, and the predetermined search step size is measured by the quantity of pixels. It should be appreciated that, in a case that the current search sub-partition completely covers the current search partition of the laser image, the quantity of pixels covered by the current search sub-partition in the second predetermined searching direction is equal to the predetermined search step size.

Preferably, in a process of repeatedly performing Step B7 in the second predetermined searching direction which is not updated, the currently-set current search sub-partition is adjacent to the previously-set current search sub-partition without any space therebetween, but they include at most one common pixel.

In Step B7, illustratively, as shown in FIG. 2, the second predetermined searching direction is a positive direction of the V-axis of the pixel coordinate system, i.e., the vertical downward direction, and the first predetermined searching direction is a positive direction of the Y-axis of the pixel coordinate system, i.e., a horizontal direction. In a case that a cell region in a ninth column is set as the current search partition, the cell region in the ninth column includes cells through which an arrow EF passes and cells through which an arrow FG passes. The cell region in which the arrow EF passes indicates a search sub-partition in the current search partition in which no light stripe center point is extracted for the first time, and the cell region through which the arrow EF passes fails to cover an upper boundary of the cell region in the ninth column, a lower boundary of the cell region in the ninth column and a right boundary of the laser image. Next, the cell region through which the arrow FG passes is set below the cell region through which the arrow EF passes in Step B7. The cell region through which the arrow FG passes is adjacent to the cell region through which the arrow EF passes, and the quantity of pixels covered by the cell region through which the arrow FG passes is equal to the quantity of pixels covered by the cell region through which the arrow EF passes. For example, the quantity of pixels covered by the cell region through which the arrow FG passes is represented by the predetermined search step size. A pixel distance between the search center of the cell region through which the arrow FG passes and the search center of the cell region through which the arrow EF passes is equal to the predetermined search step size.

In FIG. 2, it should be appreciated that, except the pixel coordinate system UOV and the cell region in the first column in the laser image, each arrow corresponds to one search sub-partition (which is supported to be updated as the current search sub-partition). Cell regions through which two arrows in a same direction in the cell region in the first column pass indicate the initial search partition, i.e., a search partition with the start center point (the white dot in the black cell in the first column) as a center-of-gravity.

Preferably, the predetermined search step size is 10, and two adjacent search sub-partitions share one pixel. In this way, a coordinate span between the search centers set in Step B which is performed twice (or between the start center points in Step C) is obvious.

Through Steps B1 and B2, the light stripe center point is extracted in the cell region through which the arrow FG passes, as indicated by a white dot in a black cell in the cell region in the ninth column. The cell region through which the arrow FG passes represents one search sub-partition in the current search partition in which the light stripe center point is extracted for the first time. Next, Step B is stopped in the cell region in the ninth column, and the light stripe center points in adjacent columns are searched through Step C.

In a word, through Steps B1 to B7, in a process of extracting the light stripe center point in the current search partition, the search center is updated in an individual search partition through moving the search center by a distance of the predetermined search step size (a pixel distance occupied by one search sub-partition) in the second predetermined searching direction or the direction opposite to the second predetermined searching direction, so that the coordinate span between two search centers (search start points) is obvious and two adjacent search pixel ranges substantially do not overlap with each other.

In the embodiments of the present disclosure, the light stripe center point extracted in a previous search partition is used as the current search center point, the current search sub-partition is set in the current search partition based on the predetermined search step size, and the light stripe center point is extracted in the current search partition based on the predetermined grayscale threshold and the grayscale center-of-gravity method. In a case that no light stripe center point is searched in the current search sub-partition, a next current search sub-partition is set in the second predetermined searching direction or the direction opposite to the second predetermined searching direction. The searching in the current search partition is stopped until the light stripe center point is extracted, or a new search partition is switched in a case that no light stripe center point is searched in the current search partition. Hence, in a case that the light stripe center point fails to be extracted in a search sub-partition of a search partition, an adjacent search sub-partition is searched in a same search partition, until the light stripe center point is extracted in the search sub-partition in the same search partition. Alternatively, in a case that the light stripe center point fails to be extracted and boundaries of a search partition in the second predetermined searching direction and the direction opposite to the second predetermined searching direction have been searched, the searching in the search partition is stopped. In addition, in a case that the light stripe center point is extracted in a search partition, a search sub-partition in a new region is switched through Step C, until the boundary of the laser image in the first predetermined searching direction has been searched, i.e., all the search partitions in the laser image have been searched. In this way, it is unnecessary to process the pixel regions overlapping with each other and search all the pixels in the laser image row by row or column by column.

Hence, in the embodiments of the present disclosure, the pixels in part of adjacent search sub-partitions or in an individual search sub-partition in each search partition (the effective pixel region inside the search sub-partition) are processed, so as to reduce a computing burden desired for extracting the center-of-gravity point of the effective pixel region based on the grayscale center-of-gravity method, thereby to rapidly extract the light stripe center point in each search partition or each light stripe partition.

In a possible embodiment of the present disclosure, Step A specifically includes the following steps. Step A1, determining whether a first search partition includes an effective pixel region based on a predetermined grayscale threshold; in a case that the first search partition includes the effective pixel region, setting the first search partition as the initial search partition, determining that the initial search partition from the plurality of search partitions in the laser image, extracting the effective pixel region in the first search partition, and proceeding to Step A2; and in a case that the first search partition does not include the effective pixel region, proceeding to Step A3. Before Step B or Step B1, Step A1 needs to be performed, so as to set the first search partition as the search partition in an initial search range for the light stripe center point in the laser image.

It should be appreciated that, in a case that Step A1 is performed for the first time, the first search partition is configured as a search partition in all the search partitions closest to the boundary of the laser image in the direction opposite to the first predetermined searching direction, e.g., the cell region in the first column in FIG. 2. The first predetermined searching direction is a positive direction of the U-axis of the pixel coordinate system, i.e., a horizontal direction. In this way, the first search partition is configured for the first time as to cover the boundary of the laser image in the direction opposite to the first predetermined searching direction, and the first search partition is configured as a first one of all the search partitions of the laser image in the first predetermined searching direction. The boundary of the laser image in the first predetermined searching direction is a boundary of the laser image to which the first predetermined searching direction points, and the boundary of the laser image in the direction opposite to the first predetermined searching direction is a boundary of the laser image to which the direction opposite to the first predetermined searching direction points, i.e., a left boundary of the laser image in FIG. 2.

Step A2, extracting a center-of-gravity point of the effective pixel region based on a grayscale center-of-gravity method, determining that the center-of-gravity point of the initial search partition has been extracted, marking the center-of-gravity point of the initial search partition as the light stripe center point of the laser stripe in the initial search partition, and determining that the first search partition has been searched and the light stripe center point has been extracted in the initial search partition.

Step A3, determining whether the first search partition covers the boundary of the laser image in the first predetermined searching direction; in a case that the first search partition covers the boundary of the laser image in the first predetermined searching direction, determining that all the search partitions in the laser image have been searched and no light stripe center point is searched in the laser image; and in a case that the first search partition does not cover the boundary of the laser image in the first predetermine searching direction, proceeding to Step A4, so as to determine whether a condition for stopping the searching is met.

Step A4, updating a search partition adjacent to the first search partition in the first predetermined searching direction as a new first search partition, and proceeding to Step A1. Hence, in a case that the currently-determined first search partition does not include the effective pixel region and does not cover the boundary of the laser image in the first predetermined searching direction, the search partition adjacent to the first search partition is updated as a new first search partition, so as to determine the first search partition including the effective pixel region in the search partitions one by one, i.e., determine the initial search partition in all the search partitions in the laser image.

In the embodiments of the present disclosure, the determining whether a to-be-searched pixel region includes the effective pixel region based on the predetermined grayscale threshold includes the following steps.

Step P1, determining whether grayscale values of pixels covered by boundaries of the to-be-searched pixel region in the second predetermined searching direction and the direction opposite to the second predetermined searching direction are greater than the predetermined grayscale threshold; in a case that the grayscale values of the pixels covered by the boundaries of the to-be-searched pixel region in the second predetermined searching direction and the direction opposite to the second predetermined searching direction are greater than the predetermined grayscale threshold, determining that the to-be-searched pixel region is the effective pixel region; and in a case that the grayscale values of the pixels covered by the boundaries of the to-be-searched pixel region in the second predetermined searching direction and the direction opposite to the second predetermined searching direction are not greater than the predetermined grayscale threshold, proceeding to Step P2. Preferably, in a case that the laser image is filtered in advance through a Gaussian filter, the predetermined grayscale threshold is greater than a grayscale threshold set in the Gaussian filter, so as to filter out the pixels in the to-be-searched pixel region whose grayscale values are close to a grayscale value of the laser stripe, thereby to improve the calculation accuracy of the center-of-gravity point (the light stripe center point) in the effective pixel region.

In the embodiments of the present disclosure, in Step A, the to-be-searched pixel region is the first search partition, so as to detect the effective pixel region. In Step B, the to-be-searched pixel region is the current search sub-partition, so as to determine whether the current search sub-partition includes the effective pixel region based on the predetermined grayscale threshold.

Step P2, sequentially searching the pixels from a boundary at one side of the to-be-searched pixel region in the second predetermined searching direction or the direction opposite to the second predetermined searching direction, and detecting a grayscale value of each pixel; in a case that the grayscale value of the searched pixel is greater than the predetermined grayscale threshold, forming the effective pixel region through the pixels with the grayscale values greater than the predetermined grayscale threshold; and in a case that the pixel with the grayscale value greater than the predetermined grayscale threshold fails to be searched, determining that the to-be-searched pixel region does not include the effective pixel region.

Alternatively, in Step P2, the pixels are sequentially searched from boundaries at two sides of the to-be-searched pixel region, and a grayscale value of each pixel is detected. In a case that a pixel with the grayscale value greater than the predetermined grayscale threshold is searched for the first time from the boundary of the to-be-searched pixel region in the second predetermined searching direction and a pixel with the grayscale value greater than the predetermined grayscale threshold is searched for the first time from the boundary of the to-be-searched pixel region in the direction opposite to the second predetermined searching direction, the pixel searched for the first time in the second predetermined searching direction and the pixel searched for the first time in the direction opposite to the second predetermined searching direction are marked as two endpoints of the effective pixel region. The effective pixel region is formed through the two endpoints and pixels between the two endpoints in the to-be-searched pixel region, and grayscale values of the pixels between the two endpoints in the to-be-searched pixel region are determined to be greater than the predetermined grayscale value, so as to filter out noise information in the too-be-search pixel region.

The effective pixel region is selected according to a gradient change rule of the grayscale values within one range (including a rule that the grayscale values gradually decrease from the center to two sides) and the predetermined grayscale threshold. On the basis of Steps P1 and P2, in a case that the to-be-searched pixel region is the first search partition, the initial search partition is determined in all the search partitions in the laser image through Steps A1 to A4. In a case that the to-be-searched pixel region is the current search sub-partition, the current search sub-partition including the effective pixel region in the corresponding search partition is determined in the laser image through Steps B1 to B7. In a case of performing Steps B1 to B7, one search sub-partition is set in each search partition, and Steps P1 and P2 need to be performed to detect whether there is the effective pixel region, so as to select all the search sub-partitions in which the center-of-gravity point (the light stripe center point) can be calculated in each search partition of the laser image.

In the embodiments of the present disclosure, for the current search sub-partition set in Step B, in a case that a pixel distance covered by the current search sub-partition in the laser image is less than the predetermined search step size, there exist the following circumstances.

In a case that a boundary of the current search sub-partition in the second predetermined searching direction is outside the laser image, pixels at a boundary of the laser image currently covered by the current search sub-partition are updated as pixels covered by the boundary of the current search sub-partition in the second predetermined searching direction. In FIG. 2, the second predetermined searching direction is the positive direction of the V-axis of the pixel coordinate system (i.e., the vertical downward direction), and boundaries of a search sub-partition corresponding to the arrow MN and a search sub-partition corresponding to the arrow 2 are outside the laser image (not shown in FIG. 2). Hence, in the search sub-partition corresponding to the arrow MN, the determination of the effective pixel region and the grayscale center-of-gravity method are performed merely with respect to the pixels in the cell region in the sixth column, and in the search sub-partition corresponding to the arrow 2, the determination of the effective pixel region and the grayscale center-of-gravity method are performed merely with respect to the pixels in the cell region in the thirteenth column. The pixels at the boundary of the laser image currently covered by the search sub-partition corresponding to the arrow MN are updated as the pixels covered by the boundary of the current search sub-partition in the second predetermined searching direction, and the pixels at the boundary of the search sub-partition corresponding to the arrow MN in the direction opposite to the second predetermined searching direction are updated as the pixels covered by the boundary of the current search sub-partition in the direction opposite to the second predetermined searching direction. In this way, the pixels covered by the boundaries of the cell region through which the arrow MN passes in the second predetermined searching direction and the direction opposite to the second predetermined searching direction are set as the pixels covered by the boundaries of the current search sub-partition in the second predetermined searching direction and the direction opposite to the second predetermined searching direction.

In a case that a boundary of the current search sub-partition in the direction opposite to the second predetermined searching direction is outside the laser image, pixels at a boundary of the laser image currently covered by the current search sub-partition are updated as pixels covered by the boundary of the current search sub-partition in the direction opposite to the second predetermined searching direction. In FIG. 2, the direction opposite to the second predetermined searching direction is the negative direction of the V-axis of the pixel coordinate system (i.e., the vertical upward direction), and a boundary of a search sub-partition corresponding to the arrow 5 in the direction opposite to the second predetermined searching direction is outside the laser image (not shown in FIG. 2). In the search sub-partition corresponding to the arrow 5, the determination of the effective pixel region and the grayscale center-of-gravity method are performed merely with respect to the pixels in the cell region in the thirteenth column. The pixels at the boundary of the laser image currently covered by the search sub-partition corresponding to the arrow 5 are updated as the pixels covered by the boundary of the current search sub-partition in the direction opposite to the second predetermined searching direction. In this way, the pixels covered by the boundaries of the cell region through which the arrow 5 passes in the second predetermined searching direction and the direction opposite to the second predetermined searching direction are set as the pixels covered by the boundaries of the current search sub-partition in the second predetermined searching direction and the direction opposite to the second predetermined searching direction.

There is no pixel outside the laser image, so the robot does not determine the effective pixel region and calculate the grayscale value of the pixel, including performing the calculation based on the grayscale center-of-gravity method, with respect to a portion of the current search sub-partition outside the current search partition.

It should be appreciated that, for the quantity of pixels indicated by the predetermined search step size or the quantity of pixels covered by the search sub-partition, a portion of each of the search sub-partitions corresponding to the arrows MN, 2 and 5 is outside the laser image, and merely the grayscale values of the pixels in the laser image are calculated.

In addition, in FIG. 2, it should be appreciated that, except the pixel coordinate system UOV and the cell region in the first column, each arrow corresponds to one search sub-partition (which is supported to be updated as the current search sub-partition). Cell regions through which two arrows in a same direction in the cell region in the first column pass indicate the initial search partition, i.e., a search partition with the start center point (the white dot in the black cell in the first column) as a center-of-gravity.

In a possible embodiment of the present disclosure, in Step B, the setting the current search center point in the current search partition based on the start center point includes: in the laser image, setting a coordinate value of the start center point in the second predetermined searching direction as a coordinate value of the current search center point in the second predetermined searching direction, so that the start center point is moved horizontally in the first predetermined searching direction to obtain the current search center point. A coordinate value of the start center point in the first predetermined searching direction is not equal to a coordinate value of the current search center point in the first predetermined searching direction. A coordinate value of a pixel in the second predetermined searching direction is a coordinate value on a first axis of a pixel coordinate system of the laser image, and a coordinate value of a pixel in the first predetermined searching direction is a coordinate value on a second axis of the pixel coordinate system of the laser image. The first axis is perpendicular to the second axis.

As shown in FIG. 2, the white dot in the black cell in the cell region in the first column is the start center point. Through Steps B and C, a coordinate value of the current search center point in the width direction of the laser stripe is equal to a coordinate value of the start center point in the width direction of the laser stripe, and the width direction of the laser stripe is parallel to a column direction of the laser image. A V-axis coordinate of the black cell in the cell region in the first column is equal to a V-axis coordinate of the current search center point set for the first time in the cell region in the second column. It should be appreciated that, the V-axis coordinate of the black cell in the cell region in the first column is equal to a V-axis coordinate of a center of a cell region through which the arrow AB passes. A V-axis coordinate of a center-of-gravity point extracted in the cell region in the first column is the V-axis coordinate of the center of the cell region through which the arrow AB passes, and the center of the cell region through which the arrow AB passes is the current search center point set for the first time in the cell region in the second column. Similarly, a V-axis coordinate of a center of a cell region through which the arrow C1D1 passes (a search center point of a corresponding search sub-partition) is a V-axis coordinate of a light stripe center point (a white dot in a black cell) extracted in the cell region in the second column, a V-axis coordinate of a center of a cell region through which the arrow C2D2 passes (a search center point of a corresponding search sub-partition) is a V-axis coordinate of a light stripe center point (a white dot in a black cell) extracted in the cell region in the sixth column, and a V-axis coordinate of a center of a cell region through which the arrow C3D3 passes (a search center point of a corresponding search sub-partition) is a V-axis coordinate of a light stripe center point (a white dot in a black cell) extracted in the cell region through which the arrow C3D3 passes. After the cell regions without any light strip center points starting from the search partition where the arrow J2K2 is located, a cell region through the arrow LM passes is a current search sub-partition set in the cell region in the sixteenth column, a V-axis coordinate of the current search center point set in the cell region through which the arrow LM passes is equal to a V-axis coordinate of the light stripe center point extracted in the cell region in the twelfth column, and the current search center point set in the cell region through which the arrow LM passes is obtained through horizontally moving the black cell in the cell region in the twelfth column (the black cell through which the arrow J2K2 passes) to the right by one cell.

Illustratively, as shown in FIG. 2, a coordinate value of a pixel in the second predetermined searching direction is an ordinate, and a coordinate value of a pixel in the first predetermined searching direction is an abscissa. In a cell region in a ninth column (a search partition where cells through which the arrow FG passes are located), a cell region in a tenth column (a search partition where cells through which the arrow J1K1 passes are located), a cell region in an eleventh column and a cell region in a twelfth column (a search partition where cells through which the arrow J2K2 passes are located), the light stripe center points are searched column by column. Ordinates of the light stripe center points extracted in the cell region in the ninth column (a search partition where cells through which the arrow FG passes are located), the cell region in the tenth column (a search partition where cells through which the arrow J1K1 passes are located), the cell region in the eleventh column and the cell region in the twelfth column (a search partition where cells through which the arrow J2K2 passes are located) are equal.

Ordinates of the current search center points set in the cell region in the tenth column (a search partition where cells through which the arrow J1K1 passes are located), the cell region in the eleventh column and the cell region in the twelfth column (a search partition where cells through which the arrow J2K2 passes are located) are equal. In addition, only one current search sub-partition is set in each cell region, and the current search sub-partitions in the cell regions are located in a same ordinate range.

In a possible embodiment of the present disclosure, the extracting the center-of-gravity point of the effective pixel region based on the grayscale center-of-gravity method includes the following steps. In a case that the first predetermined searching direction is pre-calibrated as to be parallel to an abscissa axis of the pixel coordinate system and the second predetermined searching direction is pre-calibrated to be parallel to an ordinate axis of the pixel coordinate system, an ordinate (a row-coordinate value) of the center-of-gravity point of the effective pixel region is calculated through

$${v}_{c} = \frac{{\sum }_{j = 0}^{m} j * I ( i , j )}{{\sum }_{j = 0}^{m} I ( i , j )} ,$$

where i represents an abscissa of the pixel in the effective pixel region to indicate a serial number of the effective pixel region in the laser image in the first predetermined searching direction, j represents an ordinate of the pixel in the effective pixel region to indicate a serial number of the pixel in the effective pixel region in the second predetermined searching direction, m represents the quantity of pixels in the effective pixel region, I(i,j) represents a grayscale value of a pixel (i,j), and Σ represents a summation operation.

In the embodiments of the present disclosure, the second axis is an abscissa axis for column-coordinate values (abscissas), each column in the laser image is perpendicular to the abscissa axis, and each search partition and each search sub-partition are perpendicular to the abscissa axis. The first axis is an ordinate axis for row-coordinate values (ordinates), each row in the laser image is perpendicular to the ordinate axis, and each search partition and each search sub-partition are parallel to the ordinate axis.

In the embodiments of the present disclosure, a laser stripe formed by the linear laser beam generated by the linear laser generator on a surface of the to-be-measured object or a ground surface is approximately a horizontal line parallel to a U-axis of the pixel coordinate system, so the first axis is the ordinate axis, i.e., a vertical axis of the pixel coordinate system, and the second axis is the abscissa axis, i.e., a horizontal axis of the pixel coordinate system. The first predetermined searching direction is pre-calibrated to be parallel to the abscissa axis of the pixel coordinate system, and the second predetermined searching direction is pre-calibrated to be parallel to the ordinate axis of the pixel coordinate system.

Then, coordinates of the center-of-gravity point of the effective pixel region are set as (i,v_{c}), and a light stripe center point (i,v_{c}) is extracted in the search partition where the effective pixel region is located. An ordinate v_{c} of the center-of-gravity point is less than or equal to m, and it includes a decimal part to achieve subpixel-level accuracy.

The coordinate values of the pixels in the effective pixel region in each search sub-partition or search partition and the grayscale values of the pixels are subjected to weighted averaging, so as to obtain the ordinate of the center-of-gravity point of the effective pixel region, i.e., extract the ordinate of the light stripe center point in the corresponding search sub-partition or search partition. Then, a position of the light stripe center point in the pixel coordinate system is determined based on the abscissa of the corresponding search sub-partition or search partition.

In a process of performing Steps A to C, the light stripe center points in the corresponding search partitions are obtained through traversing the laser image column by column, and the light stripe center point (or the center-of-gravity point) in each column is merely represented by the ordinate, so it is able to determine height information about the linear laser beam at a position where is reflected on a surface of an obstacle.

In another possible embodiment of the present disclosure, the extracting the center-of-gravity point of the effective pixel region based on the grayscale center-of-gravity method includes the following steps. In a case that the first predetermined searching direction is pre-calibrated to be parallel to an ordinate axis of the pixel coordinate system and the second predetermined searching direction is pre-calibrated to be parallel to an abscissa axis of the pixel coordinate system, an abscissa of the center-of-gravity point of the effective pixel region is calculated through

$${v}_{c} = \frac{{\sum }_{j = 0}^{m} j * I ( j , i )}{{\sum }_{j = 0}^{m} I ( j , i )} ,$$

where j represents an abscissa of the pixel in the effective pixel region to indicate a serial number of the pixel in the effective pixel region in the second predetermined searching direction, m represents the quantity of pixels in the effective pixel region, i represents an ordinate of the pixel in the effective pixel region to indicate a serial number of the effective pixel region in the laser image in the first predetermined searching direction, I(j,i) represents a grayscale value of a pixel (j,i), and Σ represents a summation operation.

The first axis is an abscissa axis for column-coordinate values (abscissas), each column in the laser image is perpendicular to the abscissa axis, and each search partition and each search sub-partition are parallel to the abscissa axis. The second axis is an ordinate axis for row-coordinate values (ordinates), each row in the laser image is perpendicular to the ordinate axis, and each search partition and each search sub-partition are perpendicular to the ordinate axis.

In the embodiments of the present disclosure, a laser stripe formed by the linear laser beam generated by the linear laser generator on a surface of the to-be-measured object is a line perpendicular to a ground surface and approximately parallel to the vertical axis of the pixel coordinate system, and a coordinate value of the pixel in the first predetermined searching direction is a coordinate value on the second axis of the pixel coordinate system of the laser image, so the second axis is the ordinate axis, i.e., a vertical axis of the pixel coordinate system, and the first axis is the abscissa axis, i.e., a horizontal axis of the pixel coordinate system. The first predetermined searching direction is pre-calibrated to be parallel to the ordinate axis of the pixel coordinate system, and the second predetermined searching direction is pre-calibrated to be parallel to the abscissa axis of the pixel coordinate system.

Then, coordinates of the center-of-gravity point of the effective pixel region are set as (v_{c},i), and a light stripe center point (v_{c},i) is extracted in the search partition where the effective pixel region is located. An abscissa v_{c} of the center-of-gravity point is less than or equal to m, and it includes a decimal part to achieve subpixel-level accuracy.

In a process of performing Steps A to C, the light stripe center points in the corresponding search partitions are obtained through traversing the laser image row by row, and the light stripe center point (or the center-of-gravity point) in each column is merely represented by the abscissa, so it is able to determine width information about the linear laser beam at a position where it is reflected on a surface of an obstacle.

In a possible embodiment of the present disclosure, in Step B, the setting the current search sub-partition in the second predetermined searching direction and the direction opposite to the second predetermined searching direction with the current search center point as a center includes: determining pixel regions each having a length equal to a predetermined search distance in the second predetermined searching direction and the direction opposite to the second predetermined searching direction with the current search center point as a center, and combining the pixel regions into the current search sub-partition. The predetermined search distance is a half of the predetermined search step size. In this way, the two pixel regions form the current search sub-partition in the second predetermined searching direction, and the two pixel regions are located at two sides of the current search center point in the second predetermined searching direction.

In the embodiments of the present disclosure, the predetermined search step size is measured by the quantity of pixels covered by the search sub-partition in the current search partition, and it is used to indicate a light stripe jump of the laser stripe in an individual search partition. The predetermined search step size corresponds to the quantity of pixels covered by the search sub-partition. A light stripe jump of the laser stripe in an individual search partition is smaller in a case that more pixels are indicated by the predetermined search distance, and the light stripe jump of the laser stripe in an individual search partition is larger in a case that fewer pixels are indicated by the predetermined search distance.

The linear laser generator and the camera are assembled in the robot at fixed positions, a ground medium is stable, an obstacle is in a static state, and a fluctuation in a width of the laser stripe formed by the refection of the laser beam on the surface of the to-be-measured object is small, so the collected light stripes are within a stable width range. Hence, a certain pixel search range is set for each search sub-partition, and the predetermined search step size is set as a consistent number of pixels, preferably 10.

It should be appreciated that, for one laser image, it may be converted into a grayscale image which is considered as a two-dimensional function, and a grayscale value of each pixel indicates intensity or brightness of the function at a corresponding position. Each pixel corresponds to one cell in the image. The grayscale value of the pixel is within a range of 0 to 255, and the laser image collected by the camera may be converted into a grayscale image. In the embodiments of the present disclosure, the closer to a center of the laser stripe or the light stripe, the lager the grayscale value of the pixel, and the larger the brightness. A grayscale value 0 indicates that the pixel is purely black, and a grayscale value 255 indicates that the pixel is purely white. The pixel is a smallest unit in an image which cannot be further divided, each laser image consists of a plurality of pixels, and each pixel is present in the form of a cell in a single color. In the grayscale image, one pixel is stored in the form of one byte.

The present disclosure further provides in some embodiments a robot. A body of the robot is equipped with a linear laser module, and the linear laser module includes a linear laser generator and a camera. A laser beam generated by the linear laser generator is reflected by a to-be-measured surface toward the camera to form laser stripes, i.e., the laser stripes consist of laser beam segments obtained after the laser beam is reflected by a surface of an obstacle or a ground surface on which the robot moves. The laser stripes are included in an image collected by the camera to generate a laser image for the robot. The laser stripes include a plurality of light stripe partitions in the laser image row by row or column by column, depending on a distribution mode of the laser stripes in a pixel coordinate system. The laser image is evenly divided into a plurality of search partitions in a length direction of the laser stripe, the laser stripe includes an individual light stripe partition in an individual search partition, and a center-of-gravity point of the individual light stripe partition, i.e., a light stripe center point, is calculated using a grayscale center-of-gravity method. In a case that the search partitions are present in the form of columns in a pixel coordinate system UOV in FIG. 2, the laser stripe occupies corresponding pixel coordinate positions in the form of black cells. In addition, a cell may not be occupied completely, i.e., a pixel coordinate may be indicated in the form of decimals, so as to achieve the subpixel-level accuracy. There is a light stripe center point indicated by a white dot in FIG. 2, but it needs to be searched and positioned through the above-mentioned method.

In order to reduce a computing burden, in the embodiments of the present disclosure, the length direction of the laser stripe is set as a first predetermined searching direction or a direction opposite to the first predetermined searching direction. A length of the laser stripe is greater than a width of the laser stripe. In a process of calibrating the camera, the first predetermined searching direction is configured in advance as to be parallel to a coordinate axis of the pixel coordinate system UOV, i.e., the length direction of the laser stripe is calibrated as to be parallel to the first predetermined searching direction or the first predetermined searching direction is calibrated as the length direction of the laser stripe. The length direction of the laser stripe depends on an assembling angle and an assembling height of the camera relative to the linear laser generator, specifically the assembling angle and the assembling height of the calibrated camera relative to the calibrated linear laser generator. The length direction of the laser stripe is calibrated through calibrating intrinsic parameters using a calibration plate or any other calibration tools before performing the method. In the embodiments of the present disclosure, the camera is calibrated or a direction of the coordinate axis for the laser image is corrected in advance, so that the length direction of the laser stripe is perpendicular to the width direction of the laser stripe, the width direction of the laser stripe is parallel to the second predetermined searching direction, and the length direction of the laser stripe is parallel to the first predetermined searching direction.

The robot is configured to execute the above-mentioned method. Alight stripe center point calculated in a search partition corresponds to a light stripe center point of the laser stripe in a corresponding light stripe partition. Before executing the method by the robot, the camera, e.g., an intrinsic matrix and a distortion parameter, is pre-calibrated. Relevant camera calibration functions in OpenCV are called to calibrate the laser image, so that a distribution direction of pixels in a search partition in the laser image is parallel to the width direction of the laser stripe. Before the calibration, the laser image is filtered through a Gaussian filter to reduce noises, so as to provide a smoother grayscale change in the laser image, and improve the calculation accuracy of the center-of-gravity point.

In the embodiments of the present disclosure, through Steps A to C, the robot determines the start center point in the initial search partition, and extract the light stripe center point of the laser stripe in a corresponding light stripe partition through recursive extraction of the other search partitions and search center points combined with the grayscale center-of-gravity method. The other search partition is a small pixel region defined with a predetermined light stripe center point as a search center, and the updating is performed from the start center point. As a result, it is unnecessary to search the pixels in the laser image one by one, thereby to reduce an extraction time of the search center point without adversely affecting the extraction accuracy of the light stripe center point, improve the extraction efficiency of the light stripe center point, and save memory resources. To be specific, through Steps B1 to B7, in the embodiments of the present disclosure, the light stripe center extracted in a previous search partition is used as the current search center, the current search sub-partition is set in the current search partition based on the predetermined search step size, and the light stripe center point is extracted in the current search partition based on the predetermined grayscale threshold and the grayscale center-of-gravity method. In a case that no light stripe center point is searched in the current search sub-partition, a next current search sub-partition is set in the second predetermined searching direction or the direction opposite to the second predetermined searching direction. The searching in the current search partition is stopped until the light stripe center point is extracted, or a new search partition is switched in the first predetermined searching direction in a case that no light stripe center point is searched in the current search partition. Hence, in a case that the light stripe center point fails to be extracted in a search sub-partition of a search partition, an adjacent search sub-partition is searched in a same search partition, until the light stripe center point is extracted in the search sub-partition in the same search partition. Alternatively, in a case that the light stripe center point fails to be extracted and boundaries of a search partition in the second predetermined searching direction and the direction opposite to the second predetermined searching direction have been searched, the searching in the search partition is stopped. In addition, in a case that the light stripe center point is extracted in a search partition, a search sub-partition in a new region is switched through Step C, until the boundary of the laser image in the first predetermined searching direction has been searched, i.e., all the search partitions in the laser image have been searched. In this way, it is unnecessary to process the pixel regions overlapping with each other, so as to reduce a computing burden desired for extracting the center-of-gravity point of the effective pixel region using the grayscale center-of-gravity method, and rapidly extract the light stripe center point in each search partition or each light stripe partition.

It should be appreciated that, a working principle of the linear laser module will be described as follows. The laser beams are generated by the linear laser generator toward a surface of an obstacle, and part of the laser beams are reflected by the surface of the obstacle toward the camera, so that pixels are formed through an optical imaging system in the camera. Due to different distances between the surface of the obstacle and the camera, the reflected laser beams have different time of flight. Through measuring the time of flight, it is able to obtain distance information and direction information with respect to each pixel, obtain height information and width information through trigonometric conversion, and mar them as coordinate information, i.e., position information, about the pixel in the laser image.

During the movement of the robot, it controls the linear laser generator in the linear laser module to generate the laser beam. The laser beam is reflected by the obstacle in a movement direction, and the obstacle at least includes a ground medium and a low obstacle on the ground. In addition, the robot controls the camera in the linear laser module to collect an ambient image in front of the robot. After the laser beam is reflected by the obstacle in the movement direction, laser line segments are formed on the surface of the obstacle and collected by the camera to obtain a plurality of laser stripes in rows or columns. An angle between the laser stripe and a horizontal plane will not be particularly defined herein. For example, the laser stripe may be parallel to or perpendicular to the horizontal plane, or the laser stripe may be angled relative to the horizontal plane by any angles, which may be set according to the practical need.

Each laser stripe includes a plurality of pixels, the light stripe center points of a same laser stripe are extracted in different light stripe partitions through Steps A to C, and each light stripe center point corresponds to one point on the surface of the obstacle or the ground surface, so as to form point cloud data of the obstacle. After obtaining the point cloud data of the obstacle, height information and length/width information about the obstacle are obtained, so as to identify the obstacle. In the embodiments of the present disclosure, the obstacle and a region occupied by the obstacle may be identified through various methods but not limited to the point cloud data. For example, the point cloud data of the obstacle is inputted into a deep learning model to identify the obstacle, or a contour of the obstacle is obtained according to the point cloud data of the obstacle and then the obstacle is identified according to the contour, or the obstacle is identified through clustering analysis, threshold filtration and confidence assessment.

In the embodiments of the present disclosure, a form of the linear laser generator will not be particularly defined, and it may be any device or product capable of generating a laser beam. For example, the linear laser generator includes, but not limited to, a laser tube. Identically, a form of the camera will not be particularly defined, and it includes any vision device for collecting an ambient image. For example, the camera includes, but not limited to, a monocular camera or a binocular camera. In the embodiments of the present disclosure, the laser beam generated by the linear laser generator has a wavelength equal to an infrared beam, i.e., the laser beam is an infrared laser beam, and the laser beam is emitted in a direction substantially parallel to a horizontal direction (a horizontal axis of the pixel coordinate system).

During the implementation of the method, the camera receives the laser beams at various wavelengths generated by the linear laser generator on the premise that a lens of the camera is not equipped with any filter (e.g., an infrared filter). Of course, in some embodiments of the present disclosure, an installation position and an installation angle of the linear laser generator as well as a position relationship between the linear laser generator and the camera will not be particularly defined. In the embodiments of the present disclosure, the quantity of linear laser generators will not be particularly defined, e.g., one or more linear laser generators may be provided. Identically, the quantity of cameras will not be particularly defined, e.g., one or more cameras may be provided.

In some embodiments of the present disclosure, a field of view of the camera include a vertical field of view and a horizontal field of view. In the embodiments of the present disclosure, the camera with an appropriate field of view may be selected according to the practical need, as long as the laser beam generated by the linear laser generator is within a field of view of the camera. An angle between the light stripe formed by the laser beam on the surface of the object and the horizontal plane will not be particularly defined, e.g., the light stripe may be parallel to or perpendicular to the horizontal plane, or the light stripe may be angled relative to the horizontal plane by any angles, which will be set according to the practical need.

The logic and/or steps shown in the flow charts or described in any other manner may be a sequence of executable instructions for achieving the logical functions. The instructions may be stored in any computer-readable medium, and executed by a system, unit or device (e.g., a computer-based system, a system including a processor, or any other system capable of reading the instruction from the system, unit or device), or a combination thereof. The computer-readable medium may be any unit capable of containing, storing, communicating, spreading or transferring a program which may be executed by the system, unit or device, or a combination thereof. The specific but non-exhaustive examples of the computer-readable medium may include electrical connection member (electronic device) having one or more circuits, portable computer enclosure (magnetic unit), Random Access Memory (RAM), Read Only Memory (ROM), Electrically Programmable ROM (EPROM), optical fiber unit, and Compact Disc ROM (CDROM). In addition, the computer-readable medium may also be paper onto which the program is printed or any other appropriate medium. The paper or the other appropriate medium may be scanned, compiled, interpreted or, if necessary, treated in any other appropriate manner, so as to acquire the program and store it in a memory.

The above embodiments are merely used to describe the technical concept and characteristics of the present disclosure so that a person skilled in the art can understand and implement the present disclosure, so these embodiments shall not be construed as limiting the scope of the present disclosure. A person skilled in the art may make any alterations or modifications without departing from the spirit of the present disclosure, and these alterations or modifications shall also fall within the scope of the present disclosure.

What is claimed is:

1. A method for extracting light stripe center points of laser stripes in a search partition, wherein a robot is configured to control a linear laser generator to generate a laser beam, control a camera to collect an image of the laser stripes formed through the reflection of the laser beam, and mark the image of the laser stripes as a laser image; the laser image is divided evenly into a plurality of search partitions in a length direction of a laser stripe in the laser stripes to allow that the laser stripe comprises an individual light stripe partition in an individual search partition; the length direction of the laser stripe is a first predetermined searching direction or a direction opposite to the first predetermined searching direction;
wherein the method comprises:
Step A, selecting an initial search partition from the plurality of search partitions of the laser image, extracting a center-of-gravity point of the initial search partition based on a grayscale center-of-gravity method, marking the center-of-gravity point of the initial search partition as a start center point, and determining that the initial search partition is searched, wherein in the initial search partition, a distribution direction of pixels is pre-calibrated to be parallel to a width direction of the laser stripe, and the length direction of the laser stripe is perpendicular to the width direction of the laser stripe;
Step B, setting a search partition in the plurality of search partitions adjacent to the initial search partition in the first predetermined searching direction as a current search partition, setting a current search center point in the current search partition based on the start center point, setting a current search sub-partition in a second predetermined searching direction and a direction opposite to the second predetermined searching direction with the current search center point as a center, extracting a center-of-gravity point of the current search sub-partition based on the grayscale center-of-gravity method, marking the center-of-gravity point of the current search sub-partition as a light stripe center point of the laser stripe in the current search sub-partition, and determining that the current search partition is searched and the light stripe center point i s extracted in the current search partition, wherein the second predetermined searching direction is perpendicular to the first predetermined searching direction; and
Step C, updating the current search partition as a new initial search partition, updating the light stripe center point of the laser stripe in the current search sub-partition as a new start center point, and proceeding to Step B until all the search partitions in the laser image are searched, to extract the light stripe center point of the laser stripe in the light stripe partition, wherein the light stripe center point in the current search sub-partition corresponds to the light stripe center point of the laser stripe in the corresponding light stripe partition.

2. The method according to claim 1, wherein Step B comprises:
Step B1, determining whether the current search sub-partition comprises an effective pixel region based on a predetermined grayscale threshold; in a case that the current search sub-partition comprises the effective pixel region, extracting the effective pixel region from the current search sub-partition, and proceeding to Step B2; and in a case that the current search sub-partition does not comprise the effective pixel region, proceeding to Step B3;
Step B2, extracting a center-of-gravity point of the effective pixel region based on a grayscale center-of-gravity method, determining that the center-of-gravity point of the current search sub-partition is extracted, marking the center-of-gravity point of the current search sub-partition as the light stripe center point of the laser stripe in the current search sub-partition, determining that the current search partition is searched and the light stripe center point is extracted in the current search partition, and proceeding to Step B5;
Step B3, determining whether the current search sub-partition currently covers a boundary of the current search partition in the second predetermined searching direction; in a case that the current search sub-partition currently covers the boundary of the current search partition in the second predetermined searching direction, determining that the boundary of the current search partition in the second predetermined searching direction is searched, and proceeding to Step B4; and in a case that the current search sub-partition currently does not cover the boundary of the current search partition in the second predetermined searching direction, proceeding to Step B7, wherein the boundary of the current search partition in the second predetermined searching direction is a boundary in the current search partition to which the second predetermined searching direction points, and a boundary of the current search partition in the direction opposite to the second predetermined searching direction is a boundary in the current search partition to which the direction opposite to the second predetermined searching direction points;
Step B4, determining whether the boundary of the current search partition in the direction opposite to the second predetermined searching direction is searched; in a case that the boundary of the current search partition in the direction opposite to the second predetermined searching direction is searched, proceeding to Step B5; and in a case that the boundary of the current search partition in the direction opposite to the second predetermined searching direction is not searched, updating the direction opposite to the second predetermined searching direction as the second predetermined searching direction, and proceeding to Step B6;
Step B5, determining whether the current search sub-partition currently covers a boundary of the laser image in the first predetermined searching direction; in a case that the current search sub-partition currently covers the boundary of the laser image in the first predetermined searching direction, determining that all search partitions in the laser image are searched; and in a case that the current search sub-partition currently does not cover the boundary of the laser image in the first predetermined searching direction, proceeding to Step C;
Step B6, updating a search sub-partition adjacent to the current search sub-partition set for the first time in the current search partition and covering a predetermined search step size in the updated second predetermined searching direction in Step B4 as a new current search sub-partition, and proceeding to Step B1; and
Step B7, updating the search sub-partition adjacent to the current search sub-partition and covering the predetermined search step size as a new current search sub-partition in the second predetermined searching direction, and proceeding to Step B1;
wherein the predetermined search step size is a length of the search sub-partition in the second predetermined searching direction, and the predetermined search step size is measured by the quantity of pixels.

3. The method according to claim 2, wherein Step A comprises:
Step A1, determining whether a first search partition comprises an effective pixel region based on a predetermined grayscale threshold; in a case that the first search partition comprises the effective pixel region, setting the first search partition as the initial search partition, extracting the effective pixel region in the initial search partition, and proceeding to Step A2; and in a case that the first search partition does not comprise the effective pixel region, proceeding to Step A3;
Step A2, extracting a center-of-gravity point of the effective pixel region based on a grayscale center-of-gravity method, and determining that the center-of-gravity point of the initial search partition is extracted;
Step A3, determining whether the first search partition covers a boundary of the laser image in the first predetermined searching direction; in a case that the first search partition covers the boundary of the laser image in the first predetermined searching direction, determining that all the search partitions in the laser image are searched and no light stripe center point is searched in the laser image; and in a case that the first search partition does not cover the boundary of the laser image in the first predetermine searching direction, proceeding to Step A4; and
Step A4, updating a search partition adjacent to the first search partition in the first predetermined searching direction as a new first search partition, and proceeding to Step A1,
wherein the first search partition is a search partition in the laser image closest to a boundary of the laser image in the direction opposite to the first predetermined searching direction in a case that Step A1 is performed for the first time; and
the boundary of the laser image in the direction opposite to the first predetermined searching direction is a boundary in the laser image to which the direction opposite to the first predetermined searching direction points, and the boundary of the laser image in the first predetermined searching direction is a boundary in the laser image to which the first predetermined searching direction points.

4. The method according to claim 3, wherein the determining whether a to-be-searched pixel region comprises the effective pixel region based on the predetermined grayscale threshold comprises:
Step P1, determining whether grayscale values of pixels covered by boundaries of the to-be-searched pixel region in the second predetermined searching direction and the direction opposite to the second predetermined searching direction are greater than the predetermined grayscale threshold; in a case that the grayscale values of the pixels covered by the boundaries of the to-be-searched pixel region in the second predetermined searching direction and the direction opposite to the second predetermined searching direction are greater than the predetermined grayscale threshold, determining that the to-be-searched pixel region is the effective pixel region; and in a case that the grayscale values of the pixels covered by the boundaries of the to-be-searched pixel region in the second predetermined searching direction and the direction opposite to the second predetermined searching direction are not greater than the predetermined grayscale threshold, proceeding to Step P2,
wherein the to-be-searched pixel region is the first search partition in Step A, and the to-be-searched pixel region is the current search sub-partition in Step B;
Step P2, sequentially searching the pixels from a boundary at one side of the to-be-searched pixel region in the second predetermined searching direction or the direction opposite to the second predetermined searching direction, and detecting a grayscale value of a pixel in the pixels; in a case that the grayscale value of the searched pixel is greater than the predetermined grayscale threshold, forming the effective pixel region through the pixels with the grayscale values greater than the predetermined grayscale threshold; and in a case that the pixel with the grayscale value greater than the predetermined grayscale threshold fails to be searched, determining that the to-be-searched pixel region does not comprise the effective pixel region, wherein the boundary at one side of the to-be-searched pixel region is a boundary of the to-be-searched pixel region in the second predetermined searching direction or a boundary of the to-be-searched pixel region in the direction opposite to the second predetermined searching direction; or
sequentially searching the pixels from boundaries at two sides of the to-be-searched pixel region, and detecting a grayscale value of a pixel in the pixels; in a case that a pixel with the grayscale value greater than the predetermined grayscale threshold is searched for the first time from the boundary of the to-be-searched pixel region in the second predetermined searching direction and a pixel with the grayscale value greater than the predetermined grayscale threshold is searched for the first time from the boundary of the to-be-searched pixel region in the direction opposite to the second predetermined searching direction, marking the pixel searched for the first time in the second predetermined searching direction and the pixel searched for the first time in the direction opposite to the second predetermined searching direction as two endpoints of the effective pixel region, forming the effective pixel region with the two endpoints and pixels between the two endpoints in the to-be-searched pixel region, and determining that grayscale values of the pixels between the two endpoints in the to-be-searched pixel region are greater than the predetermined grayscale value.

5. The method according to claim 4, wherein in a case that a pixel distance covered by the current search sub-partition in the laser image is less than the predetermined search step size, there exist the following circumstances:
in a case that a boundary of the current search sub-partition in the second predetermined searching direction is outside the laser image, updating pixels at a boundary of the laser image currently covered by the current search sub-partition as pixels covered by the boundary of the current search sub-partition in the second predetermined searching direction; and in a case that a boundary of the current search sub-partition in the direction opposite to the second predetermined searching direction is outside the laser image, updating pixels at a boundary of the laser image currently covered by the current search sub-partition as pixels covered by the boundary of the current search sub-partition in the direction opposite to the second predetermined searching direction,
wherein no pixels are provided outside the laser image.

6. The method according to claim 2, wherein in Step B, the setting the current search center point in the current search partition based on the start center point comprises:
in the laser image, setting a coordinate value of the start center point in the second predetermined searching direction as a coordinate value of the current search center point in the second predetermined searching direction;
wherein a coordinate value of the start center point in the first predetermined searching direction is not equal to a coordinate value of the current search center point in the first predetermined searching direction; and
a coordinate value of a pixel in the second predetermined searching direction is a coordinate value on a first axis of a coordinate system of the laser image, and a coordinate value of a pixel in the first predetermined searching direction is a coordinate value on a second axis of the pixel coordinate system of the laser image.

7. The method according to claim 6, wherein the extracting the center-of-gravity point of the effective pixel region based on the grayscale center-of-gravity method comprises:
in a case that the first predetermined searching direction is pre-calibrated as to be parallel to an abscissa axis of the pixel coordinate system and the second predetermined searching direction is pre-calibrated to be parallel to an ordinate axis of the pixel coordinate system, calculating an ordinate of the center-of-gravity point of the effective pixel region through
$${v}_{c} = \frac{{\sum }_{j = 0}^{m} j * I ( i , j )}{{\sum }_{j = 0}^{m} I ( i , j )} ,$$
wherein i represents an abscissa of the pixel in the effective pixel region to indicate a serial number of the effective pixel region in the laser image in the first predetermined searching direction, j represents an ordinate of the pixel in the effective pixel region to indicate a serial number of the pixel in the effective pixel region in the second predetermined searching direction, m represents the quantity of pixels in the effective pixel region, I(i,j) represents a grayscale value of a pixel (i,j), the first axis is an ordinate axis, and the second axis is an abscissa axis; and
setting coordinates of the center-of-gravity point of the effective pixel region as (i,v_{c}), wherein the ordinate v_{c} of the center-of-gravity point is less than or equal to m.

8. The method according to claim 6, wherein the extracting the center-of-gravity point of the effective pixel region based on the grayscale center-of-gravity method comprises:
in a case that the first predetermined searching direction is pre-calibrated to be parallel to an ordinate axis of the pixel coordinate system and the second predetermined searching direction is pre-calibrated to be parallel to an abscissa axis of the pixel coordinate system, calculating an abscissa of the center-of-gravity point of the effective pixel region through
$${v}_{c} = \frac{{\sum }_{j = 0}^{m} j * I ( j , i )}{{\sum }_{j = 0}^{m} I ( j , i )} ,$$
where j represents an abscissa of the pixel in the effective pixel region to indicate a serial number of the pixel in the effective pixel region in the second predetermined searching direction, m represents the quantity of pixels in the effective pixel region, i represents an ordinate of the pixel in the effective pixel region to indicate a serial number of the effective pixel region in the first predetermined searching direction, I(j,i) represents a grayscale value of a pixel (j,i), the first axis is an abscissa axis, and the second axis is an ordinate axis; and
setting coordinates of the center-of-gravity point of the effective pixel region as (v_{c},i), wherein the abscissa v_{c} of the center-of-gravity point is less than or equal to m.

9. The method according to claim 2, wherein in Step B, the setting the current search sub-partition in the second predetermined searching direction and the direction opposite to the second predetermined searching direction with the current search center point as a center comprises:
determining pixel regions each having a length equal to a predetermined search distance in the second predetermined searching direction and the direction opposite to the second predetermined searching direction with the current search center point as a center, and combining the pixel regions into the current search sub-partition;
wherein the predetermined search distance is a half of the predetermined search step size, a light stripe jump of the laser stripe in an individual search partition is smaller in a case that more pixels are indicated by the predetermined search distance, and the light stripe jump of the laser stripe in an individual search partition is larger in a case that fewer pixels are indicated by the predetermined search distance.

10. A robot, wherein a body of the robot is equipped with a linear laser module, the linear laser module comprises a linear laser generator and a camera; a laser beam generated by the linear laser generator is reflected by a to-be-measured surface toward the camera to form laser stripes;
the laser stripes are comprised in an image collected by the camera to generate a laser image for the robot;
the laser stripes comprise a plurality of light stripe partitions in the laser image; the laser image is evenly divided into a plurality of search partitions in a length direction of the laser stripe;
the robot is configured to execute a method for extracting light stripe center points of laser stripes in a search partition, a light stripe center point calculated in a search partition in the plurality of search partitions corresponds to a light stripe center point of the laser stripe in a corresponding light stripe partition in the plurality of light stripe partitions; and
before executing the method by the robot, the camera is pre-calibrated in such a manner that a distribution direction of pixels in a search partition in the plurality of search partitions in the laser image is parallel to a width direction of the laser stripe; and the length direction of the laser stripe is perpendicular to the width direction of the laser stripe, the width direction of the laser stripe is parallel to a second predetermined searching direction, and the length direction of the laser stripe is parallel to a first predetermined searching direction,
wherein the method comprises:
Step A, selecting an initial search partition from the plurality of search partitions of the laser image, extracting a center-of-gravity point of the initial search partition based on a grayscale center-of-gravity method, marking the center-of-gravity point of the initial search partition as a start center point, and determining that the initial search partition is searched, wherein in the initial search partition, a distribution direction of pixels is pre-calibrated to be parallel to a width direction of the laser stripe, and the length direction of the laser stripe is perpendicular to the width direction of the laser stripe;
Step B, setting a search partition in the plurality of search partitions adjacent to the initial search partition in the first predetermined searching direction as a current search partition, setting a current search center point in the current search partition based on the start center point, setting a current search sub-partition in a second predetermined searching direction and a direction opposite to the second predetermined searching direction with the current search center point as a center, extracting a center-of-gravity point of the current search sub-partition based on the grayscale center-of-gravity method, marking the center-of-gravity point of the current search sub-partition as a light stripe center point of the laser stripe in the current search sub-partition, and determining that the current search partition is searched and the light stripe center point is extracted in the current search partition, wherein the second predetermined searching direction is perpendicular to the first predetermined searching direction; and
Step C, updating the current search partition as a new initial search partition, updating the light stripe center point of the laser stripe in the current search sub-partition as a new start center point, and proceeding to Step B until all the search partitions in the laser image are searched, to extract the light stripe center point of the laser stripe in the light stripe partition, wherein the light stripe center point in the current search sub-partition corresponds to the light stripe center point of the laser stripe in the corresponding light stripe partition.
